(19) United States
(12) Patent Application Publication
(10) Pub. No.: US 2026/0100466 A1
(43) Pub. Date: Apr. 9, 2026

(54) STACK HOUSING FOR BATTERY MODULES AND BATTERY SYSTEM INCLUDING THE SAME

(71) Applicants: HYUNDAI MOTOR COMPANY, Seoul (KR); KIA CORPORATION, Seoul (KR)

(72) Inventors: SEGI KANG, Hwaseong-si (KR); HYEONSU JIN, Hwaseong-si (KR); BEOMSIK PARK, Hwaseong-si (KR)

(21) Appl. No.: 19/020,294

(22) Filed: Jan. 14, 2025

(30) Foreign Application Priority Data
Oct. 8, 2024 (KR) 10-2024-0136348

(51) Int. Cl. H01M 50/262; H01M 50/204; H01M 50/258

(52) U.S. Cl. CPC H01M 50/262; H01M 50/204; H01M 50/258

(57) ABSTRACT

A stack housing for battery modules includes a multi-case, an arched mount, a stack layer, and a damping bracket. The multi-case defines loading compartments that are configured to hold multiple battery modules in a divided arrangement and positioned side-by-side at a set height. The arched mount connects the loading compartments and creates a defined space. The stack layer, attached to a top of the arched mount, serves as a frame allowing battery modules to be stacked on the multi-case. The damping bracket connects ends of the stack layer and includes a downwardly bent middle portion coupled to the arched mount.

### CROSS-REFERENCE TO RELATED APPLICATIONS

This application is based on and claims the benefit of 35 U.S.C. 119 to Korean Patent Application No. 10-2024-0136348, filed on Oct. 8, 2024, in the Korean Intellectual Property Office, the disclosure of which is herein incorporated by reference in its entirety.

### TECHNICAL FIELD

The present disclosure relates to a stack housing for battery modules and a battery system including the same, and more particularly to a stack housing capable of stably receiving a plurality of battery modules in a stacked state and protecting the battery modules from external shock or vibration and a battery system including the same.

### BACKGROUND

A battery system mounted in an electric vehicle may include a battery cell, a battery module, and a housing or case configured to protect and receive the same. In the battery system, the design of the housing or the case may be important.

For instance, the battery system may be mounted in a lower part of an electric vehicle to lower the center of gravity of the electric vehicle and to increase stability of the vehicle's body. In some cases, the housing or the case applied to the battery system may be designed in different sizes and shapes depending on various electric vehicle platforms ranging from light vehicles to vans and trucks.

While the battery system may be mounted in a specific space such as a hexahedral space, a certain platform such as vans or trucks may limit the space available for the battery system, where the housing or the case may be designed based on the volume and shape of the limited space.

### SUMMARY

The present disclosure describes a stack housing that can provide a sufficient space for a battery system to be mounted under a center floor of a vehicle body, where a drive shaft connects a powertrain to front or rear wheels.

The present disclosure describes a stack housing that can improve stability of the battery system when the shape of the battery system is designed to avoid the major components under the center floor.

The present disclosure describes a stack housing that can reduce the complexity in shape of a battery housing which may increase the overall weight of the battery system, and the stack housing can facilitate replacement and maintenance of the battery cells or battery modules.

According to one aspect of the subject matter described in this application, a stack housing includes a multi-case that defines a plurality of loading compartments that are arranged side by side and have a predetermined height, where each of the plurality of loading compartments is configured to receive a plurality of battery modules. The stack housing further includes an arched mount that connects the plurality of loading compartments, the arched mount defining a space between the plurality of loading compartments, a stack layer coupled to a top of the arched mount, the stack layer defining a frame that supports the plurality of battery modules stacked in the multi-case, and a plurality of damping brackets, each of the plurality of damping brackets having (i) a first end and a second end that are attached to the stack layer and (ii) a middle portion that is downwardly bent and coupled to the arched mount.

Implementations according to this aspect can include one or more of the following features. For example, the arched mount can have an arched curved structure that includes a closed top portion and an open bottom portion. In some implementations, the arched mount can include a pair of opposing walls that are positioned side by side and face each other, a pair of bent portions that extend from top portions of the pair of opposing walls, respectively, and are curved upward and toward each other, and a load-bearing surface that connects the pair of bent portions to each other, the load-bearing surface being flat and facing upward.

In some implementations, the stack layer can include the plurality of damping brackets, a pair of transverse frames that extend across top portions of the plurality of loading compartments and are parallel to each other, and a pair of longitudinal frames that are coupled to the pair of transverse frames, respectively, and are parallel to each other, where the plurality of damping brackets are arranged parallel to the pair of transverse frames and connect the pair of longitudinal frames across the load-bearing surface. In some examples, the pair of transverse frames can define recesses at positions where the pair of longitudinal frames intersect with the pair of longitudinal frames, respectively, where the stack housing can include fastening members that are inserted into the recesses of the pair of transverse frames and that couple the pair of transverse frames to the pair of longitudinal frames.

In some implementations, each of the pair of transverse frames can include a center girder that extends downward from a middle part of one of the pair of transverse frames, the center girder defining a girder coupling surface that faces and contacts the load-bearing surface, and bent support portions that are disposed at sides of the center girder, wherein a length of one of the bent support portions increases as a distance from the center girder to the one of the bent support portions decreases, where a width of a lower end of the center girder defines a contact area between the girder coupling surface and the load-bearing surface.

In some implementations, each of the pair of transverse frames can have a maximum cross-sectional area at a middle part thereof, where a cross-sectional area of one of the pair of transverse frames decreases from the middle part toward ends of the one of the pair of transverse frames.

In some implementations, each of the plurality of damping brackets can include coupling ends attached to lower surfaces of the pair of longitudinal frames, a bent portion disposed between the coupling ends and bent downward from the coupling ends, and a protrusion that protrudes upward from the bent portion and extends along the bent portion in a longitudinal direction between the coupling ends.

According to one aspect of the subject matter described in this application, a battery system for electric vehicles includes the stack housing described above. In addition, the battery system further includes a single-layer module array of battery modules disposed in at least one of the plurality of loading compartments, a middle plate coupled to at least a part of an upper surface of the single-layer module array, a double-layer module array of battery modules positioned at a top of the stack layer, and a top plate coupled to the upper surface of the double-layer module array, where the stack layer is fixed to the load-bearing surface and the middle plate.

### BRIEF DESCRIPTION OF THE DRAWINGS

The above and other objects, features and other advantages of the present disclosure will be more clearly understood from the following detailed description taken in conjunction with the accompanying drawings.

FIG. 1 is a schematic view illustrating an example of a battery system.

FIG. 2 is an exploded perspective view illustrating an example of a stack housing for battery modules.

FIG. 3 is a perspective view showing an example of a stack layer in the stack housing for battery modules.

FIG. 4 is a plan view showing the stack layer in the stack housing for battery modules.

FIG. 5 is a partial perspective view illustrating an example of intersection of a transverse frame and a longitudinal frame in the stack housing for battery modules.

FIG. 6 is a perspective view showing an example of a multi-case in the stack housing for battery modules.

FIG. 7 is a perspective view showing an example of a damping bracket in the stack housing for battery modules.

FIG. 8 is a perspective view showing the transverse frame in the stack housing for battery modules.

FIG. 9 is a Y-Z plane sectional view illustrating an example structure in which each of the transverse frame and the damping bracket is coupled to a load bearing surface of an arched mount in the stack housing for battery modules.

### DETAILED DESCRIPTION

Hereinafter, one or more implementations will be described in detail with reference to the accompanying drawings. Identical or similar components are denoted by identical or similar reference numerals, and redundant descriptions can be omitted.

A first direction (X), a second direction (Y), and a third direction (Z) described herein refer to dimensions and directionalities in three-dimensional coordinates used to represent a three-dimensional shape. Thus, the first direction (X), the second direction (Y), and the third direction (Z) refer to directions in dimensions orthogonal to each other.

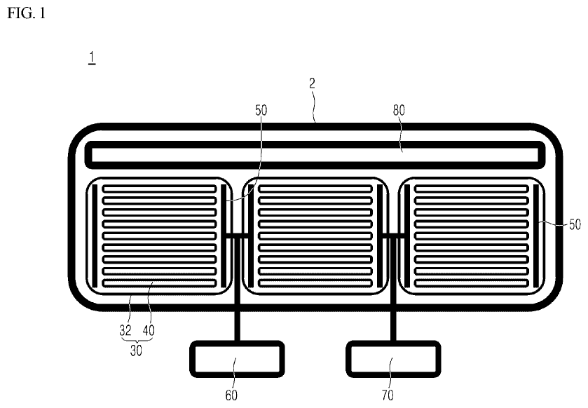

FIG. 1 is a schematic view illustrating an example of a battery system. Referring to FIG. 1, a battery cell 40 can be a basic unit for storing and supplying energy in an electric vehicle. In some examples, a lithium-ion battery can used, where each battery cell 40 includes a positive electrode (+), a negative electrode (−), an electrolyte, and a separator. The performance of the battery cell 40 can affect the range, charging speed, and lifespan of the electric vehicle.

A battery module 30 is a structure in which a plurality of battery cells 40 is disposed in a predetermined arrangement such that the battery cells 40 can reliably operate.

The battery module 30 can be configured in the form in which the plurality of battery cells 40 is received in a module case 32. The battery module 30 can further include a thermal management system, such as a cooling module 80, or an electrical circuit, such as a busbar unit 50, for thermal and electrical management between the battery cells 40.

A battery housing 2 can protect the battery module 30 from external shock, vibration, and environmental hazards. The battery housing 2 can be configured to reduce physical shock or vibration that occur during vehicle driving, and to safely maintain the stacking and arrangement of battery modules 30. In addition, the battery housing can be designed to facilitate replacement and maintenance of the battery cells 40 and the battery modules 30.

In some examples, the battery modules 30 can be connected to a battery management system (BMS). The battery management system monitors and controls the state of charge, temperature, voltage, and the like of the battery system in real time to improve safety and efficiency of the battery system, and can further include a charging unit 60 for charging and a power supply unit 70 for power supply.

In some implementations, the housing or the case in which the plurality of battery modules 30 is received can be referred to as a battery pack, and the structure in which various devices for electrical connection, electrical insulation, fire protection, cooling, and the like are coupled to the battery pack can be referred to as a battery system.

The present disclosure describes a stack housing for battery modules 30 and a battery system 1 including the same.

The stack housing for battery modules 30 according to the present disclosure provides a structure that effectively receives the battery modules 30 and effectively reduces vibration and shock. This will be described in detail as follows.

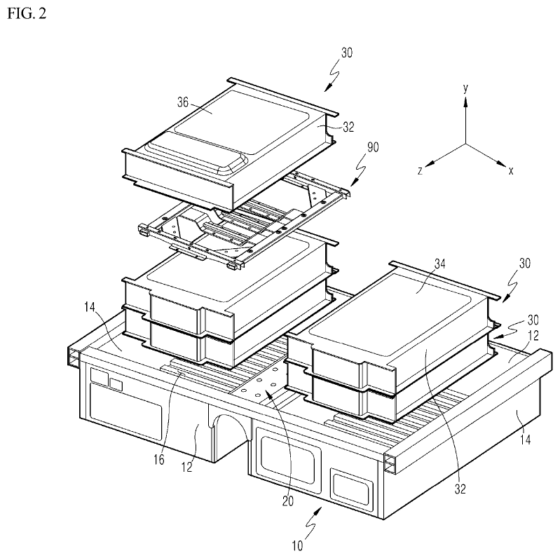

FIG. 2 is an exploded perspective view illustrating a stack housing for battery modules 30.

In some implementations, as shown in FIG. 2, the stack housing includes a multi-case 10, an arched mount 20, a stack layer 90, and a damping bracket 400.

In some examples, the multi-case 10 can include at least two loading compartments. The loading compartments can have a predetermined height and disposed side by side. Each of the loading compartments can receive at least one battery module 30. In some examples, as shown, battery modules 30 can be received in each loading compartment in a state of being stacked in several layers, such as two layers or three layers.

The multi-case 10 includes a plurality of loading compartments, each of which receives at least one battery module 30.

Battery modules 30 loaded in one multi-case 10 can be disposed as a single layer over a relatively large area in an X-Y plane.

In the stack housing, a pair of loading compartments can be formed side-by-side in one multi-case 10, and each loading compartment receives at least one battery module 30. The layer of battery modules 30 received in the loading compartments of the multi-case 10 in a divided state will be referred to as a single-layer module array.

The arched mount 20 can define a space having a predetermined shape between the loading compartments and connects adjacent loading compartments to each other.

In some examples, the arched mount 20 can have the form of an inverted U-shaped arch tunnel. That is, an inverted U-shaped arch tunnel is formed between a pair of loading compartments, and the part of the arch tunnel corresponding to the ceiling connects the loading compartments to each other in a longitudinal direction of the arch tunnel.

That is, the arched mount 20 can be an arched curved structure that divides the loading compartments from each other, forms a space having a predetermined shape between the loading compartments, and is closed at the top and open at the bottom.

The stack layer 90 is a frame formed to allow the battery module 30 to be stacked on the top of the multi-case 10, and is coupled to the top of the arched mount 20.

The stack layer 90 is the basis for additionally forming a double-layer module array on the single-layer module array, which is the layer of battery modules 30 received in the multi-case 10. The stack layer 90 allows battery modules 30 to be additionally placed on top of the single-layer module array formed by the battery modules 30 received in the multi-case 10 to form a double-layer module array.

The damping bracket 400 is a structure in which both ends are coupled to the stack layer 90, wherein a middle portion is curved downward, and the curved middle portion is coupled to the arched mount 20. The damping bracket 400 can be provided in plural.

A middle plate 34 or a top plate 36 can be coupled to an upper surface of each of the battery modules 30.

The exposed upper surface of each of the battery modules 30 received in the loading compartments of the multi-case 10 is covered by the middle plate 34 so as to be protected. The middle plate 34 is a plate-shaped member that covers the upper surface of each battery module 30 for protection and allows a separate battery module 30 to be coupled to the upper surface to form a double-layer module array.

The middle plate 34 can be provided with a plurality of fastening holes H and/or assembly holes C.

In the stack housing, the top plate 36 is coupled to and covers an upper surface of the battery module 30 forming the uppermost double-layer module array and protects the battery module 30 forming the double-layer module array.

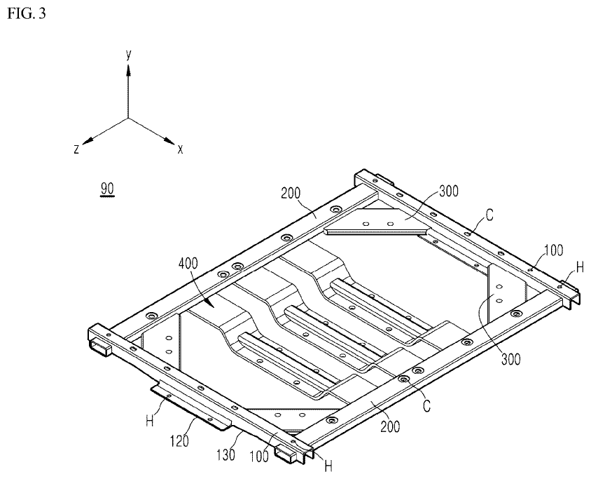

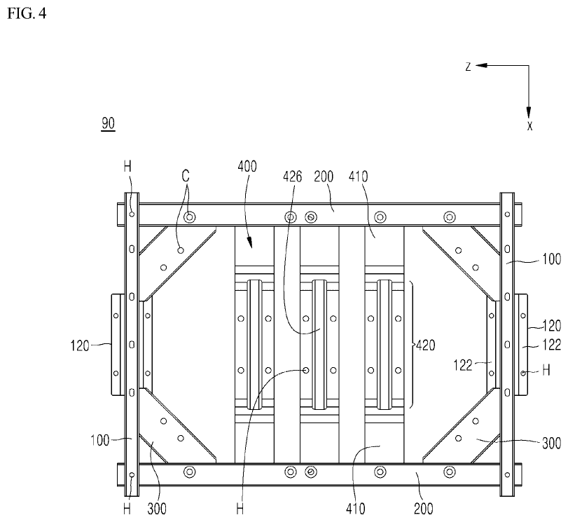

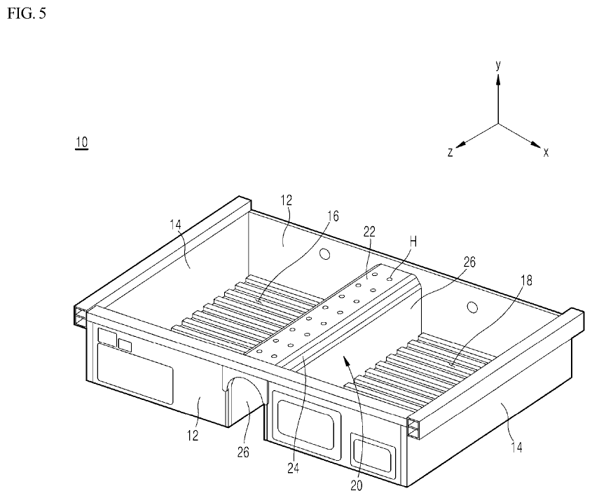

FIG. 3 is a perspective view showing the stack layer 90 in the stack housing for battery modules 30, FIG. 4 is a plan view of the stack layer 90 in the stack housing for battery modules 30, and FIG. 5 is a partial perspective view illustrating the intersection of a transverse frame 100 and a longitudinal frame 200 in the stack housing for battery modules 30.

As shown in FIGS. 3 and 4, the stack layer 90 can be implemented as a rectangular frame having a predetermined size formed in an X-Z plane.

The stack layer 90 has the shape of a series of frames in which the battery module 30 can be loaded on the top thereof.

A pair of transverse frames 100 and a pair of longitudinal frames 200 are coupled to form a framework of the stack layer 90. Specifically, a pair of transverse frames 100 disposed parallel with each other is connected to each other by a pair of longitudinal frames 200 also disposed parallel with each other to form a quadrangular framework.

The pair of transverse frames 100 can be short sides parallel with each other in the rectangular framework structure, and the pair of longitudinal frames 200 can be long sides parallel with each other in the rectangular framework structure.

The transverse frames 100 and the longitudinal frames 200 can include a plurality of fastening holes H and a plurality of assembly holes C, respectively. The fastening holes H and the assembly holes C can be through-holes formed through the transverse frames 100 and longitudinal frames 200, respectively, in an upward-downward direction. A fastening member B can be fastened to each of the fastening holes H and/or assembly holes C to firmly couple the stack layer 90 to the multi-case 10.

In some implementations, the fastening member B can be implemented as a bolt, a rib, or any other fastening means, for instance.

In the stack layer 90, a pair of transverse frames 100 extending in an X-axis direction is disposed in parallel, and opposite ends of the transverse frames 100 are connected to each other via a pair of longitudinal frames 200. The longitudinal frames 200 are straight members extending in a z-axis direction. The transverse frames 100 and the longitudinal frames 200 form a rectangular framework. Reinforcement frames 300 for structural rigidity reinforcement can be further coupled to the inside of the rectangular framework formed by the transverse frames 100 and the longitudinal frames 200.

The reinforcement frames 300 are coupled to the rectangular framework formed by the transverse frames 100 and the longitudinal frames 200 so as to be adjacent to the four corners, and connect the transverse frames 100 and the longitudinal frames 200 to further reinforce the stack layer 90.

The stack layer 90 can further include a plurality of damping brackets 400. Each of the damping brackets 400 is a linear structure that is disposed parallel with the transverse frames 100 and connects the longitudinal frames 200 by coupling.

As shown, each damping bracket 400 can be a plate having a predetermined width and extending in the X-axis direction.

One end of the damping bracket 400 is coupled to a lower surface of one longitudinal frame 200, and the other end of the damping bracket 400 is coupled to a lower surface of the other longitudinal frame 200. Each damping bracket 400 connects the longitudinal frames 200 across the inside of the rectangular framework of the stack layer 90 so as to be parallel with the transverse frames 100 in the rectangular framework.

The damping brackets 400 function to absorb vibration and shock from battery modules 30 stacked in multiple rows and multiple stages.

Each damping bracket 400 includes a coupling end 410 and a bent portion 420.

Each damping bracket 400 is provided at opposite ends thereof with coupling ends 410 that are flat and are coupled to lower surfaces of the longitudinal frame 200, respectively. The bent portion 420, at least a part of which is bent downward, is formed at the middle portion of each damping bracket between the pair of coupling ends 410.

That is, each damping bracket 400 is an elongated linear plate member, wherein the coupling ends 410 formed at both ends are coupled to the longitudinal frames 200, respectively, and a part of the middle portion, which is a downwardly bent part, constitutes the bent portion 420.

The load of the battery module 30, which is placed on the stack layer 90, is supported by the quadrangular framework constituted by the transverse frames 100 and the longitudinal frames 200. The bent portion 420 of each damping bracket 400 is coupled to the arched mount 20 of the multi-case 10.

The bent portion 420 of the damping bracket 400 is a downwardly bent part and is the point where the single-layer module array and the double-layer module array are connected to each other. The bent portion 420 protects the battery modules 30 by absorbing vibration and shock while minimizing structural deformation between the single-layer module array and the double-layer module array.

As shown in FIG. 5, the transverse frames 100 and the longitudinal frames 200 serve as the main support structure forming the stack layer 90. The transverse frames 100 and the longitudinal frames 200 are connected to each other while intersecting each other at right angles. Specifically, each transverse frame 100 has fitting recesses 110 formed at positions adjacent to both ends. Each longitudinal frame 200 includes fitting ends 210 formed at the points where the longitudinal frame intersects the transverse frame 100, and the fitting ends 210 of the longitudinal frame 200 are fitted into the fitting recesses 110 provided in the transverse frame 100 from the bottom to the top.

Fastening holes H can be formed at the points where the fitting recesses 110 and the fitting ends 210 are formed, i.e., the intersections between the transverse frame 100 and the longitudinal frame 200, and fastening members B extending linearly through the transverse frame 100 and the longitudinal frame 200 in an upward-downward direction can be received in the fastening holes H formed in the arched mount 20 or the middle plate 34 so as to be coupled thereto.

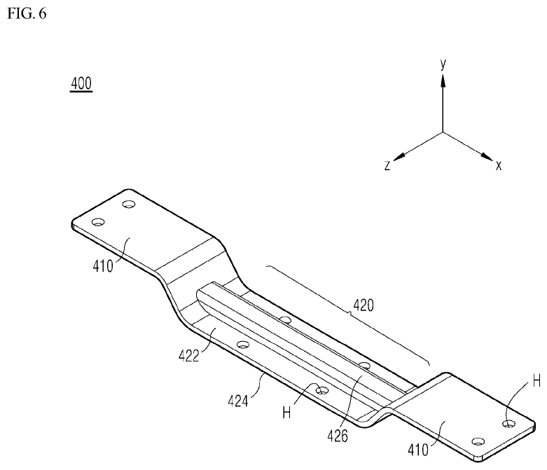

FIG. 6 is a perspective view showing the multi-case 10 in the stack housing for battery modules 30.

As shown in FIG. 6, the multi-case 10 includes a pair of loading compartments, each of which is formed so as to receive a battery module 30 having a cuboidal shape.

The loading compartments are disposed side by side with the arched mount 20 therebetween.

In the figure, the left loading compartment will be referred to as a first loading compartment 16 and the right loading compartment will be referred to as a second loading compartment 18.

The multi-case 10 can have the shape of a hexahedral box with an open top.

The multi-case 10 can include four walls constituted by transverse wall units 12 parallel with each other and longitudinal wall units 14 parallel with each other.

The arched mount 20 is provided in the middle of the space formed by the transverse wall units 12 and the longitudinal wall units 14. The arched mount 20 connects a pair of transverse wall units 12 in parallel with each other such that a tunnel-shaped space is formed between the transverse wall units 12.

The arched mount 20 includes a pair of opposing walls 26. The opposing walls 26 are surfaces parallel with the longitudinal wall units 14 and are constituted by walls orthogonal to the transverse wall units 12.

In addition, a passageway that opens downwardly of the multi-case 10 is formed between the opposing walls 26,

Upper ends of the opposing walls 26 are connected to each other via an arched structure. The arched mount 20 includes a load bearing surface 22, which is a middle portion between the opposing walls 26 and at least a part of which is flat, and bent portions 24, which are bent portions formed along both sides of the load bearing surface 22 and which connect the load bearing surface 22 and the upper ends of the opposing walls 26 to each other in an arch shape in a longitudinal direction.

In the stack housing, the multi-case 10 can include a first loading compartment 16 and a second loading compartment 18, wherein the first loading compartment 16 and the second loading compartment 18 can be divided from each other by the arched mount 20 that partitions the space in the multi-case 10.

In some implementations, the multi-case 10 can include a plurality of loading compartments, and any suitable form of arched mount 20 can be formed as the structure that divides the loading compartments from each other.

Each of the first loading compartment 16 and the second loading compartment 18 receives a battery module 30. The battery modules 30 received in the first loading compartment 16 and the second loading compartment 18 form a single-layer module array, as described above. An upper surface of each of the battery module 30 received in the first loading compartment 16 and the battery module 30 received in the second loading compartment 18 is covered by the middle plate 34 so as to be protected.

A plurality of fastening holes H and/or assembly holes C can be formed in the load bearing surface 22 of the arched mount 20, and the stack layer 90 is coupled to the load bearing surface 22 of the arched mount 20.

The stack layer 90 can abut the arched mount 20 and be coupled to the top of the arched mount 20, and both sides of the stack layer can extend to both sides of the load bearing surface 22 so as to cover at least a part of the top of each of the first loading compartment 16 and the second loading compartment 18.

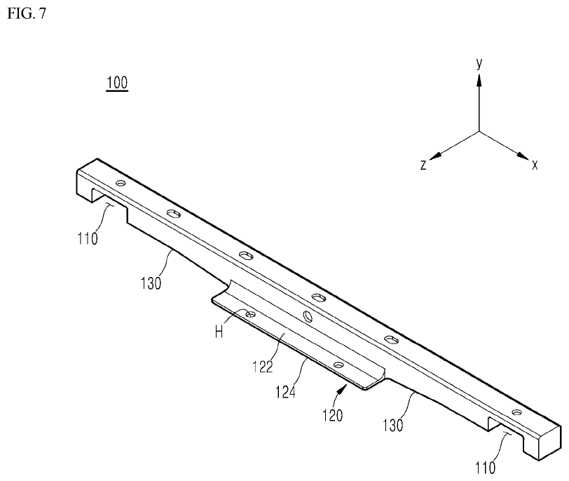

FIG. 7 is a perspective view showing the damping bracket 400 in the stack housing for battery modules 30.

The damping bracket 400 can be provided in plural so as to be coupled to the stack layer 90. The damping brackets 400 increase the structural rigidity of the stack layer 90 by connecting middle portions of a pair of parallel longitudinal frames 200.

As shown in FIG. 7, the damping bracket 400 has coupling ends 410 formed at both ends, and a middle portion between the coupling ends 410 includes a bent portion 420 that is at least partially bent in a downward direction.

The bent portion 420 is a middle portion that is bent downward relative to the coupling ends 410, resulting in a reduced height. At least a part of the bent portion 420 is flat, wherein an upper surface of the flat part is a bent surface 422 and a lower surface of the flat part is a bent coupling surface 424.

The bent portion 420 can be provided with a plurality of fastening holes H and/or assembly holes C, and can be coupled to the arched mount 20 via a plurality of fastening members B in the state in which the bent coupling surface 424 abuts the load bearing surface 22 of the arched mount.

The battery modules 30 can be stacked on and coupled to the top of the stack layer 90, and the battery modules 30 coupled to the top of the stack layer 90 constitute a double-layer module array.

The battery modules 30 constituting the double-layer module array and the battery modules 30 constituting the single-layer module array are subjected to reduced vibration and load effects due to the structural features of the damping bracket 400 and the arched mount 20.

In addition, each damping bracket 400 can further include a forming protrusion 426.

The forming protrusion 426 has a three-dimensional structure that protrudes or is depressed in the longitudinal direction of the bent surface 422 or the bent coupling surface 424 of the bent portion 420.

The forming protrusion 426 provides a structural capable of further enhancing the structure of the stack layer 90 and at the same time more safely protecting the battery modules 30 stacked in multiple layers (in addition to that the bent surface 422 of the damping bracket 400, which is a downwardly bent surface, reduces shock propagation between the upper and lower layers and efficiently distributes vibration or load).

The forming protrusion 426 helps to minimize fatigue damage that can occur during prolonged use of the stack housing and the battery system 1.

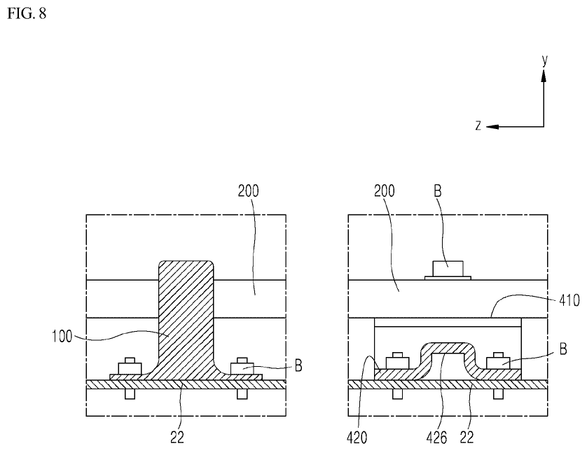

FIG. 8 is a perspective view showing the transverse frame 100 in the stack housing for battery modules 30.

As shown in FIG. 8, a pair of transverse frames 100 can have the same shape, and each transverse frame includes fitting recesses 110 formed at positions adjacent to both ends and a center girder 120 provided at a middle portion and formed thicker than both ends.

Each transverse frame 100 is a straight member, and the section thereof basically can have a rectangular shape elongated in the upward-downward directions, as shown.

The transverse frame 100 has fitting recesses 110 formed at positions adjacent to both ends. The fitting recesses 110 are downwardly open recesses, into which the coupling ends 410 of the longitudinal frames 200 coupled thereto in an intersecting state are fitted.

An upper end of the transverse frame 100 is formed flat, and a lower end portion of the transverse frame gradually protrudes downward with decreasing distance from a middle portion.

That is, the transverse frame 100 is gradually thicker toward the middle portion and gradually thinner toward both ends.

The center girder 120 is provided at a lower end of the middle portion of the transverse frame 100.

The center girder 120 is formed at a part of the middle of the transverse frame 100, which is the point at which the thickness of the transverse frame 100 is the maximum. The center girder 120 can include a girder expansion surface 122 and a girder coupling surface 124.

The center girder 120 can include wing-shaped members extending to both sides of the transverse frame 100, wherein an upper surface of the center girder 120 extending from a lower end of the transverse frame 100 to each of both sides is the girder expansion surface 122, and a lower surface having a wing shape extending to each of both sides of the transverse frame 100 is the girder coupling surface 124.

The transverse frame 100 can have a plurality of fastening holes H and/or assembly holes C formed in the longitudinal direction. The part of the center girder 120 extending to each of both sides of the transverse frame 100 can also have a plurality of fastening holes H and/or assembly holes C.

The center girder 120 provided at each transverse frame 100 is coupled to the arched mount 20 at the position corresponding thereto. Specifically, the center girder 120 of the transverse frame 100 is placed on the top of the arched mount 20, and the girder coupling surface 124, which is the lower surface of the center girder 120, abuts the load bearing surface 22. In the state in which the girder coupling surface 124 and the load bearing surface 22 are in contact with each other, the center girder 120 and the load bearing surface 22 are coupled to each other via a fastening member B, such as a bolt.

Alternatively, in some examples, the girder coupling surface 124 can be coupled to the upper surface of the middle plate 34, which covers and protects the first loading compartment 16 or the second loading compartment 18, in contact therewith.

Each transverse frame 100 can include a bent support portion 130, wherein the bent support portion 130 is the part of the transverse frame 100 that is located between the fitting recess 110 formed at each end and the center girder 120 and is gradually inclined downward, becoming gradually thicker in the downward direction with decreasing distance from the center girder 120.

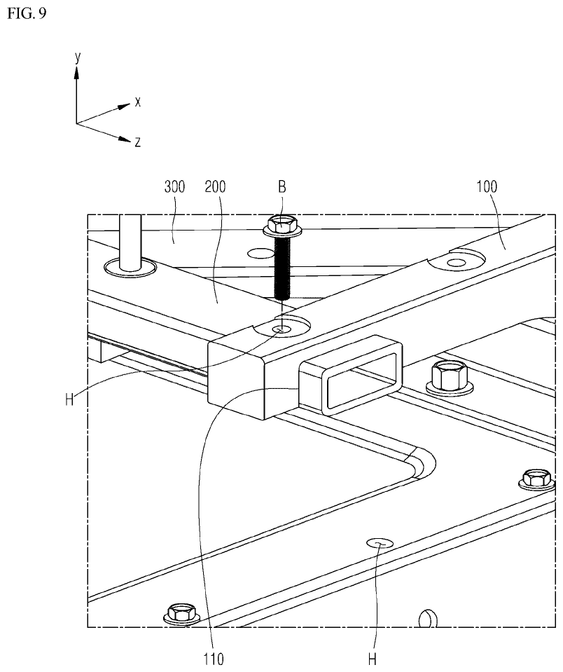

FIG. 9 is a Y-Z plane sectional view illustrating the structure in which each of the transverse frame 100 and the damping bracket 400 is coupled to the load bearing surface 22 of the arched mount 20 in the stack housing for battery modules 30.

As shown in FIG. 9, in the stack housing, the stack layer 90 is interposed between the single-layer module array and the double-layer module array. The stack layer 90 firmly fixes the single-layer module array and the double-layer module array in a stacked state.

In addition, the stack layer flexibly disperses and reduces vibration or shock that can occur between the single-layer module array and the double-layer module array.

Referring to the left view of FIG. 9, the center girder 120 formed at the middle portion of the transverse frame 100 is fixed in direct contact with the load bearing surface 22 or the upper surface of the middle plate 34. The sectional area of the transverse frame 100 is gradually decreased toward each of both sides from the center girder 120, and a pair of longitudinal frames 200 coupled to both ends of the transverse frame 100 is relatively flexibly deformed in response to vibration or shock.

Referring to the right view of FIG. 9, the middle portion of the stack layer 90 is coupled to the arched mount 20 forming a single-layer module array via a plurality of damping brackets 400. Both ends of each damping bracket 400 are coupled to lower surfaces of the longitudinal frames 200, and the bent coupling surface 424, which is a lower surface of the bent portion 420 formed at the middle portion, is coupled to the load bearing surface 22 in contact therewith.

Each damping bracket 400 can perform primary damping of vibration and impact due to the structural features of the bent portion 420, and the forming protrusion 426 formed in the longitudinal direction of the bent portion 420 allow the damping bracket 400 to have structural rigidity while flexibly coping with external force.

A battery system 1 includes a stack housing. In addition, the battery system can include a single-layer module array, a middle plate 34, a double-layer module array, and a top plate 36.

The single-layer module array is a single layer constituted by a plurality of battery modules 30 received in loading compartments.

The middle plate 34 is coupled to at least a part of an upper surface of the single-layer module array so as to cover the upper surface.

The double-layer module array is a layer constituted by battery modules 30 coupled to the top of a stack layer 90.

The top plate 36 is coupled to an upper surface of the double-layer module array so as to cover the upper surface.

The stack layer 90 is fixed in contact with a load bearing surface 22 and/or the middle plate 34.

According to the present disclosure it is possible to provide a stack housing that can be stacked in multiple stages by differently changing disposition of the battery modules in each stage, so as to make it easy to avoid a major configuration such as a drive shaft under the center floor of a vehicle body.

According to the present disclosure, it is possible to more freely design the overall shape of a battery system depending on the conditions under the center floor.

According to the present disclosure, it is possible to implement a battery system configured such that load distribution and shock mitigation between layers are smoothly performed while a plurality of battery modules is stacked in multiple stages, whereby durability is improved.

According to the present disclosure, it is possible to provide a structure that reliably protects a plurality of battery modules and easily maintains the plurality of battery modules even when the plurality of battery modules is stacked in multiple stages and disposed.

Effects of the present disclosure are not limited to the aforementioned effects, and other unmentioned effects of the present disclosure will be clearly understood by those skilled in the art from the above description.

Implementations of the present disclosure have been described above with reference to the drawings. The described implementations and the drawings are given by way of example and are not intended to limit the present disclosure.

In some cases, the present disclosure can be modified within the scope of the described technical ideas.

The described implementations are to be considered as part of the present disclosure, and the scope of the present disclosure is not limited to the described implementations.

The scope of the present disclosure is to be determined by the technical ideas recited in the claims.

Even if the described implementations do not explicitly describe the operation or effect of a specific construction, the operation or effect that can be predicted by the construction is within the scope of the present disclosure.

What is claimed is:

1. A stack housing, comprising:
a multi-case that defines a plurality of loading compartments that are arranged side by side and have a predetermined height, each of the plurality of loading compartments being configured to receive a plurality of battery modules;
an arched mount that connects the plurality of loading compartments, the arched mount defining a space between the plurality of loading compartments;
a stack layer coupled to a top of the arched mount, the stack layer defining a frame that supports the plurality of battery modules stacked in the multi-case; and
a plurality of damping brackets, each of the plurality of damping brackets having (i) a first end and a second end that are attached to the stack layer and (ii) a middle portion that is downwardly bent and coupled to the arched mount.

2. The stack housing according to claim 1, wherein the arched mount has an arched curved structure that includes a closed top portion and an open bottom portion.

3. The stack housing according to claim 2, wherein the arched mount comprises:
a pair of opposing walls that are positioned side by side and face each other;
a pair of bent portions that extend from top portions of the pair of opposing walls, respectively, and are curved upward and toward each other; and
a load-bearing surface that connects the pair of bent portions to each other, the load-bearing surface being flat and facing upward.

4. The stack housing according to claim 3, wherein the stack layer comprises:
the plurality of damping brackets;
a pair of transverse frames that extend across top portions of the plurality of loading compartments and are parallel to each other; and
a pair of longitudinal frames that are coupled to the pair of transverse frames, respectively, and are parallel to each other, and
wherein the plurality of damping brackets are arranged parallel to the pair of transverse frames and connect the pair of longitudinal frames across the load-bearing surface.

5. The stack housing according to claim 4, wherein the pair of transverse frames define recesses at positions where the pair of longitudinal frames intersect with the pair of longitudinal frames, respectively, and
wherein the stack housing further comprises fastening members that are inserted into the recesses of the pair of transverse frames and that couple the pair of transverse frames to the pair of longitudinal frames.

6. The stack housing according to claim 4, wherein each of the pair of transverse frames comprises:
a center girder that extends downward from a middle part of one of the pair of transverse frames, the center girder defining a girder coupling surface that faces and contacts the load-bearing surface; and
bent support portions that are disposed at sides of the center girder, wherein a length of one of the bent support portions increases as a distance from the center girder to the one of the bent support portions decreases, and
wherein a width of a lower end of the center girder defines a contact area between the girder coupling surface and the load-bearing surface.

7. The stack housing according to claim 4, wherein each of the pair of transverse frames has a maximum cross-sectional area at a middle part thereof, and a cross-sectional area of one of the pair of transverse frames decreases from the middle part toward ends of the one of the pair of transverse frames.

8. The stack housing according to claim 4, wherein each of the plurality of damping brackets comprises:
coupling ends attached to lower surfaces of the pair of longitudinal frames;
a bent portion disposed between the coupling ends and bent downward from the coupling ends; and
a protrusion that protrudes upward from the bent portion and extends along the bent portion in a longitudinal direction between the coupling ends.

9. A battery system for electric vehicles, comprising:
the stack housing according to claim 3;
a single-layer module array of battery modules disposed in at least one of the plurality of loading compartments;
a middle plate coupled to at least a part of an upper surface of the single-layer module array;
a double-layer module array of battery modules positioned at a top of the stack layer; and
a top plate coupled to the upper surface of the double-layer module array,
wherein the stack layer is fixed to the load-bearing surface and the middle plate.

10. A battery system for electric vehicles, comprising:
a stack housing comprising:
a multi-case that defines a plurality of loading compartments that are arranged side by side and have a predetermined height, each of the plurality of loading compartments being configured to receive a plurality of battery modules,
an arched mount that connects the plurality of loading compartments, the arched mount defining a space between the plurality of loading compartments,
a stack layer coupled to a top of the arched mount, the stack layer defining a frame that supports the plurality of battery modules stacked in the multi-case, and
a plurality of damping brackets, each of the plurality of damping brackets having (i) a first end and a second end that are attached to the stack layer and (ii) a middle portion that is downwardly bent and coupled to the arched mount;
a single-layer module array of battery modules disposed in at least one of the plurality of loading compartments;
a middle plate coupled to at least a part of an upper surface of the single-layer module array;
a double-layer module array of battery modules positioned at a top of the stack layer; and
a top plate coupled to the upper surface of the double-layer module array.

11. The battery system of claim 10, wherein the stack layer and the double-layer module array are disposed above the arched mount between the plurality of loading compartments.
